(19) United States
(12) Patent Application Publication
(10) Pub. No.: US 2026/0000980 A1
(43) Pub. Date: Jan. 1, 2026

(54) VIRTUAL OBJECT TRANSFORMATION

(71) Applicant: Tencent Technology (Shenzhen) Company Limited, Shenzhen (CN)

(72) Inventor: Lulu HOU, Shenzhen (CN)

(73) Assignee: Tencent Technology (Shenzhen) Company Limited, Shenzhen, GD (CN)

(21) Appl. No.: 19/318,327

(22) Filed: Sep. 3, 2025

Related U.S. Application Data
(63) Continuation of application No. PCT/CN2024/098746, filed on Jun. 12, 2024.

(30) Foreign Application Priority Data
Aug. 25, 2023 (CN) 202311083020.5

(51) Int. Cl. A63F 13/52; A63F 13/57

(52) U.S. Cl. CPC A63F 13/52; A63F 13/57

(57) ABSTRACT

In a virtual object transformation method, a first virtual object and at least one virtual item in a virtual environment are output for display. The virtual environment includes a second virtual object that searches for the first virtual object. The output for display of the first virtual object is switched to a first virtual item of the at least one virtual item based on a camouflage operation being performed on the first virtual object. Each of the at least one virtual item has an associated item type. The first virtual item has an item type matching one of the associated item types. The first virtual item is controlled to perform an action in the virtual environment based on a control operation performed on the first virtual item.

### RELATED APPLICATIONS

The present application is a continuation of International Application No. PCT/CN2024/098746, filed on Jun. 12, 2024, which claims priority to Chinese Patent Application No. 202311083020.5, filed on Aug. 25, 2023. The entire disclosures of the prior applications are hereby incorporated by reference.

### FIELD OF THE TECHNOLOGY

This application relates to the field of virtual world technologies, including a virtual object transformation method.

### BACKGROUND OF THE DISCLOSURE

In applications including a virtual environment, it is often necessary to control virtual objects to perform activities such as walking, driving, climbing, picking up items, and battling in the virtual environment.

In related art, a player of a first virtual camp in the virtual environment is displayed as a virtual item, and hides by moving in the virtual environment, and a player of a second virtual camp perform searching in the virtual environment.

However, a selection manner of the foregoing virtual item is relatively limited.

### SUMMARY

Aspects of this disclosure provide a virtual object transformation method, a virtual object transformation apparatus, and a device, and a non-transitory computer-readable storage medium. Examples of technical solutions of this disclosure may be implemented as follows:

An aspect of this disclosure provides a virtual object transformation method. In the method, a first virtual object and at least one virtual item in a virtual environment are output for display. The virtual environment includes a second virtual object that searches for the first virtual object. The output for display of the first virtual object is switched to a first virtual item of the at least one virtual item based on a camouflage operation being performed on the first virtual object. Each of the at least one virtual item has an associated item type. The first virtual item has an item type matching one of the associated item types. The first virtual item is controlled to perform an action in the virtual environment based on a control operation performed on the first virtual item.

An aspect of this disclosure provides a virtual object transformation apparatus. The apparatus includes processing circuitry configured to output for display a first virtual object and at least one virtual item in a virtual environment, the virtual environment including a second virtual object that searches for the first virtual object. The processing circuitry is configured to switch the output for display of the first virtual object to a first virtual item of the at least one virtual item based on a camouflage operation being performed on the first virtual object. Each of the at least one virtual item has an associated item type. The first virtual item has an item type matching one of the associated item types. The processing circuitry is configured to control the first virtual item to perform an action in the virtual environment based on a control operation performed on the first virtual item.

An aspect of this disclosure provides a virtual object transformation method. The method is performed by a terminal and includes: displaying a first virtual object and at least one environmental virtual item that are located in a virtual environment, the virtual environment being an environment for a second virtual object to search for a deformed first virtual object; and the first virtual object and the second virtual object having opposite identities; switching the display of the first virtual object to a first virtual item in response to a camouflage operation on the first virtual object, a type range of the first virtual item being a subset of a type range of the at least one environmental virtual item; and controlling, in response to a control operation on the first virtual item, the first virtual item to move in the virtual environment.

An aspect of this disclosure provides a virtual object transformation apparatus. The apparatus includes: a display module, configured to display a first virtual object and at least one environmental virtual item that are located in a virtual environment, the virtual environment being an environment for a second virtual object to search for a deformed first virtual object; and the first virtual object and the second virtual object having opposite identities; the display module being further configured to switch the display of the first virtual object to a first virtual item in response to a camouflage operation on the first virtual object, a type range of the first virtual item being a subset of a type range of the at least one environmental virtual item; and the display module being further configured to control, in response to a control operation on the first virtual item, the first virtual item to move in the virtual environment.

An aspect of this disclosure provides a computer device. The computer device includes a processor and a memory, the memory having at least one instruction, at least one program, and a code set or an instruction set stored therein, the at least one instruction, the at least one program, and the code set or the instruction set being loaded and executed by the processor to implement the virtual object transformation method according to the foregoing aspects.

An aspect of this disclosure provides a non-transitory computer-readable storage medium, having computer-executable instructions stored therein, the computer-executable instructions, when executed by a processor, cause the processor to implement the virtual object transformation method according to the foregoing aspects.

An aspect of this disclosure provides a computer program product. The computer program product includes computer instructions, the computer instructions being stored in a computer-readable storage medium, a processor reading the computer instructions from the computer-readable storage medium, and executing the computer instructions, to implement the virtual object transformation method according to the foregoing aspects.

The technical solutions provided in this disclosure include at least the following beneficial effects:

By performing the camouflage operation to switch the display of the first virtual object, the display of the first virtual object is changed to the first virtual item, changing the appearance of the first virtual object. The changed first virtual item is of the same type as the at least one environmental virtual item, ensuring that an environmental virtual item having the same appearance as the first virtual item exists in the virtual environment. This facilitates hiding in the virtual environment by using the appearance of the first virtual item, thereby expanding manners of changing the appearance of the virtual object in the virtual environment.

### BRIEF DESCRIPTION OF THE DRAWINGS

FIG. 1 is a structural block diagram of a computer system according to an aspect of this disclosure.

FIG. 2 is a schematic diagram of a virtual object transformation method according to an aspect of this disclosure.

FIG. 3 is a flowchart of a virtual object transformation method according to an aspect of this disclosure.

FIG. 4 is a flowchart of a virtual object transformation method according to an aspect of this disclosure.

FIG. 5 is a schematic diagram of a three-dimensional model according to an aspect of this disclosure.

FIG. 6 is a flowchart of a virtual object transformation method according to an aspect of this disclosure.

FIG. 7 is a schematic diagram of a virtual environment identifier according to an aspect of this disclosure.

FIG. 8 is a flowchart of a virtual object transformation method according to an aspect of this disclosure.

FIG. 9 is a flowchart of a virtual object transformation method according to an aspect of this disclosure.

FIG. 10 is a schematic diagram of a random pool according to an aspect of this disclosure.

FIG. 11 is a structural block diagram of a virtual object transformation apparatus according to an aspect of this disclosure.

FIG. 12 is a structural block diagram of a terminal according to an aspect of this disclosure.

### DETAILED DESCRIPTION

Descriptions of terms in this disclosure are provided as examples only and are not intended to limit the scope of the disclosure.

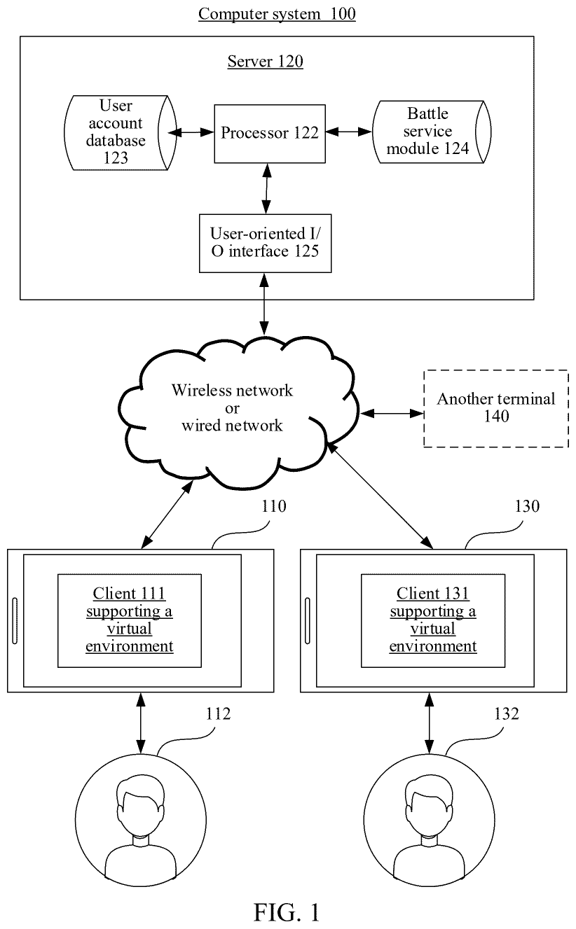

FIG. 1 is a structural block diagram of a computer system according to an aspect of this disclosure. The computer system 100 includes: a first terminal 110, a server 120, and a second terminal 130.

A client 111 supporting a virtual environment is installed and run on the first terminal 110. The client 111 may be a multiplayer online battle program. When the first terminal runs the client 111, a user interface of the client 111 is displayed on a screen of the first terminal 110. The client 111 may be any one of a battle royale shooting game, a virtual reality (VR) application, an augmented reality (AR) application, a three-dimensional map application, a VR game, an AR game, a first-person shooting (FPS) game, a third-person shooting (TPS) game, a multiplayer online battle arena (MOBA) game, or a simulation game (SLG). In this aspect, an example in which the client 111 is an FPS game is used for description. The first terminal 110 is a terminal used by a first user 112. The first user 112 uses the first terminal 110 to control a first virtual object located in the virtual environment to perform activities, and the first virtual object may be referred to as a virtual object of the first user 112. The activities of the first virtual object include, but are not limited to: at least one of moving, jumping, teleporting, releasing skills, using props, adjusting body postures, crawling, walking, running, riding, flying, jumping, driving, picking, shooting, attacking, or throwing. For example, the first virtual object is a first virtual character such as a simulated human character or an animated human character.

A client 131 supporting a virtual environment is installed and run on the second terminal 130. The client 131 may be a multiplayer online battle program. When the second terminal 130 runs the client 131, a user interface of the client 131 is displayed on a screen of the second terminal 130. The client may be any one of a battle royale shooting game, a VR application, an AR application, a three-dimensional map application, a VR game, an AR game, an FPS, a TPS, a MOBA, or an SLG. In this aspect, an example in which the client is a MOBA game is used for description. The second terminal 130 is a terminal used by a second user 132. The second user 132 uses the second terminal 130 to control a second virtual object located in the virtual environment to perform activities, and the second virtual object may be referred to as a virtual object of the second user 132. For example, the second virtual object is a second virtual character such as a simulated human character or an animated human character.

In some aspects, the first virtual object and the second virtual object are located in the same virtual environment. In some aspects, the first virtual object and the second virtual object may belong to the same camp, the same team, or the same organization, have a friend relationship with each other, or have a temporary communication permission. In some aspect, the first virtual object and the second virtual object may belong to different camps, different teams, or different organizations, or have a hostile relationship with each other.

In some aspects, the clients installed on the first terminal 110 and the second terminal 130 are the same, or the clients installed on the two terminals are the same type of clients of different operating system platforms (Android system or iOS system). The first terminal 110 may be one of a plurality of terminals, and the second terminal 130 may be another one of the plurality of terminals. In this aspect, the first terminal 110 and the second terminal 130 are merely used as an example for description. Device types of the first terminal 110 and the second terminal 130 are the same or different. The device types include: at least one of a smartphone, a tablet computer, an e-book reader, an MP3 player, an MP4 player, a laptop portable computer, or a desktop computer.

FIG. 1 shows only two terminals, but a plurality of other terminals 140 may access the server 120 in different aspects. In some aspects, one or more terminals 140 are also terminals corresponding to a developer. A development and editing platform of the client supporting the virtual environment is installed on the terminal 140. The developer may edit and update the client on the terminal 140, and transmit an updated client installation package to the server 120 by using a wired network or a wireless network. The first terminal 110 and the second terminal 130 may download the client installation package from the server 120 to update the client.

The first terminal 110, the second terminal 130, and the another terminal 140 are connected to the server 120 by using a wireless network or a wired network.

The server 120 includes at least one of one server, a plurality of servers, a cloud computing platform, or a virtualization center. The server 120 is configured to provide a background service for a client supporting a three-dimensional virtual environment. In some aspects, the server 120 is responsible for primary computing work, and the terminal is responsible for secondary computing work; or the server 120 is responsible for secondary computing work, and the terminal is responsible for primary computing work; or a distributed computing architecture is used between the server 120 and the terminal to perform collaborative computing.

In an example, the server 120 includes a processor 122, a user account database 123, a battle service module 124, and a user-oriented input/output interface (I/O interface) 125. The processor 122 is configured to load instructions stored in the server 120, and process data in the user account database 123 and the battle service module 124. The user account database 123 is configured to store data of user accounts used by the first terminal 110, the second terminal 130, and the another terminal 140, for example, avatars of the user accounts, nicknames of the user accounts, battle effectiveness indexes of the user accounts, and service zones of the user accounts. The battle service module 124 is configured to provide a plurality of battle rooms for the user to battle, for example, a 1V1 battle, a 3V3 battle, and a 5V5 battle. The user-oriented I/O interface 125 is configured to establish, by using a wireless network or a wired network, communication between the first terminal 110 and/or the second terminal 130 for data exchange.

The method provided in this disclosure may be applied to, but is not limited to, at least one of the following scenarios: a VR application, a three-dimensional map application, a first-person shooting (FPS) game, a third-person shooting (TPS) game, a multiplayer online battle arena (MOBA) game, or a multilayer gunfight survival game. The following aspects are described by using an application in a game as an example.

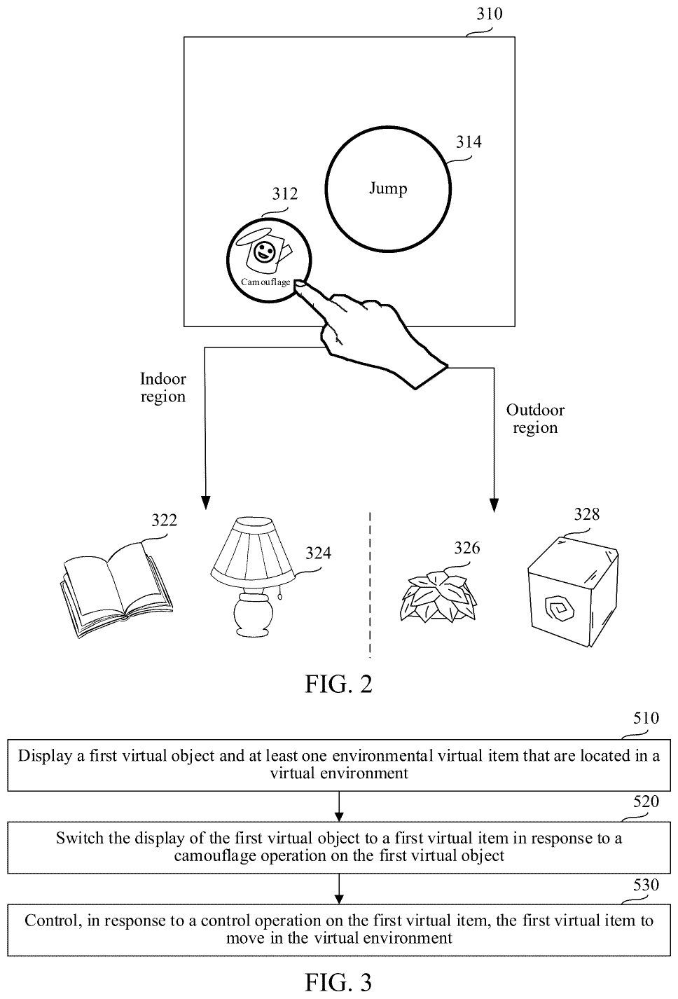

FIG. 2 is a schematic diagram of a virtual object transformation method according to an aspect of this disclosure.

For example, in an evasion game match, a virtual camp in which the first virtual object is located may be referred to as a stealth side or an evading side, and a virtual camp in which the second virtual object is located may be referred to as a guarding side or a searching side. After a virtual battle match starts, the first virtual object blends into environmental virtual items arranged in a virtual environment by changing its appearance to avoid being found by the second virtual object. The second virtual object needs to find, from a plurality of environmental virtual items in the virtual environment, a first virtual item transformed from the first virtual object, and perform a virtual attack. After being found by the second virtual object, the first virtual object may use the terrain to perform a movement operation such as running or jumping, for disguising again.

For example, a first region 310 is a display region on the display screen of the terminal for displaying a camouflage control 312 and a jump control 314, and the display screen of the terminal is configured to display the first virtual object and at least one environmental virtual item that are in the virtual environment.

The display of the first virtual object is switched to the first virtual item in response to a tap operation on the camouflage control 312. Specifically, for a case in which the first virtual object is located in an indoor region, that is, the position of the first virtual object is inside a virtual building, the display of the first virtual object is switched to a virtual book 322 or a virtual desk lamp 324. The virtual book 322 or the virtual desk lamp 324 is an environmental virtual item that already exists in the indoor region. For a case in which the first virtual object is located in an outdoor region, that is, the position of the first virtual object is outside a virtual building, the display of the first virtual object is switched to a virtual grass cluster 326 or a virtual rock 328. The virtual grass cluster 326 or the virtual rock 328 is an environmental virtual item that already exists in the outdoor region.

FIG. 3 is a flowchart of a virtual object transformation method according to an aspect of this disclosure. An example in which the method is applied to the terminal is used for description. The method includes the following operations:

Operation 510: Display a first virtual object and at least one environmental virtual item that are located in a virtual environment. For example, a first virtual object and at least one virtual item in a virtual environment are output for display. The virtual environment includes a second virtual object that searches for the first virtual object.

For example, the virtual environment is an environment for a second virtual object to search for a deformed first virtual object. For example, the first virtual object and the second virtual object have opposite identities. For example, the second virtual object and the first virtual object belong to different virtual camps. The second virtual object searches for the transformed first virtual object in the virtual environment, and the first virtual object hides in the virtual environment through transformation, to perform a virtual match between the first virtual object and the second virtual object.

For example, a virtual scene is a virtual scene displayed (or provided) by an application when run on a terminal or a server. In some aspects, the virtual scene is a simulated environment of a real world, or a semi-simulated and semi-fictional virtual environment, or an entirely fictional virtual environment. The virtual scene is any one of a two-dimensional virtual scene, a 2.5-dimensional virtual scene, or a three-dimensional virtual scene. The virtual environment may be sky, land, ocean, or the like. The land includes environmental elements such as desert or cities.

For example, the environmental virtual item is a virtual item that already exists in the virtual environment, such as at least one of a virtual tree, a virtual animal, a virtual box, a virtual flower pot, virtual stairs, or a virtual curtain. The virtual environment may have a plurality of environmental virtual items with the same appearance.

For example, the first virtual object and the second virtual object are player characters controlled by control accounts logged in on different terminals. For example, the first virtual object is a virtual object controlled by a control account currently logged in on a terminal. For example, displaying the first virtual object includes directly displaying the first virtual object, or displaying a viewpoint picture of the first virtual object. The viewpoint picture of the first virtual object is a scene picture obtained after the virtual environment is observed from the viewpoint of the first virtual object. In some aspects of this disclosure, a virtual character is observed in the virtual environment by using a camera model.

Operation 520: Switch the display of the first virtual object to a first virtual item in response to a camouflage operation on the first virtual object. For example, the output for display of the first virtual object is switched to a first virtual item of the at least one virtual item based on a camouflage operation being performed on the first virtual object. Each of the at least one virtual item has an associated item type. The first virtual item has an item type matching one of the associated item types.

For example, the camouflage operation is configured for switching the display of an appearance of the first virtual object, and the camouflage operation is an operation on the first virtual object. Operations that may trigger switching the display of the first virtual object are all camouflage operations on the first virtual object. Implementations of the camouflage operation on the first virtual object include, but are not limited to, at least one of the following: tapping, sliding, or rotating, for example: tapping on a touchscreen or a key, sliding on a touchscreen or a game controller, and rotating a terminal or a game controller.

For example, a type range of the first virtual item is a subset of a type range of the at least one environmental virtual item. For example, environmental virtual items of the same type have the same appearance. As described above, the virtual environment may include a plurality of environmental virtual items having the same appearance, and the plurality of environmental virtual items having the same appearance correspond to the same type of environmental virtual item.

For example, the display of the first virtual object is switched to the first virtual item, and the environmental virtual item in the virtual environment is simulated by switching the display of the first virtual object to the first virtual item having the same appearance as the environmental virtual item.

For example, the first virtual item is any environmental virtual item in the virtual environment. Further, the first virtual item may be determined from the at least one environmental virtual item, or may be selected based on a human-computer interaction operation, or may be determined based on a mapping relationship between the first virtual object and the first virtual item. A manner of determining the first virtual item is not limited in this disclosure. In an example, the first virtual item and the at least one environmental virtual item are of the same type, but the first virtual item and the environmental virtual item having the same type are different virtual items. For example, the first virtual item and the environmental virtual item differ in position. For example, the environmental virtual item is a first virtual tree, and the first virtual item is a second virtual tree. The first virtual item of the same type as the environmental virtual item. For example, an appearance of the second virtual tree is the same as that of the first virtual tree. However, in the virtual environment, the first virtual tree and the second virtual tree are two different virtual items that are independent of each other.

Operation 530: Control, in response to a control operation on the first virtual item, the first virtual item to move in the virtual environment. For example, the first virtual item is controlled to perform an action in the virtual environment based on a control operation performed on the first virtual item.

For example, the control operation on the first virtual item is configured for controlling the first virtual item to perform at least one of virtual activities such as moving, jumping, climbing, running, and staying stationary in the virtual environment. By controlling the first virtual item to perform activities in the virtual environment, the position of the first virtual item in the virtual environment is adjusted to hide from the second virtual object searching in the virtual environment.

In conclusion, by performing the camouflage operation to switch the display of the first virtual object, the display of the first virtual object is changed to the first virtual item, changing the appearance of the first virtual object. The changed first virtual item is of the same type as the at least one environmental virtual item, ensuring that an environmental virtual item having the same appearance as the first virtual item exists in the virtual environment. This facilitates hiding in the virtual environment by using the appearance of the first virtual item, thereby expanding manners of changing the appearance of the virtual object in the virtual environment.

Next, a manner of determining the first virtual item based on a visual difference or a visual similarity is described.

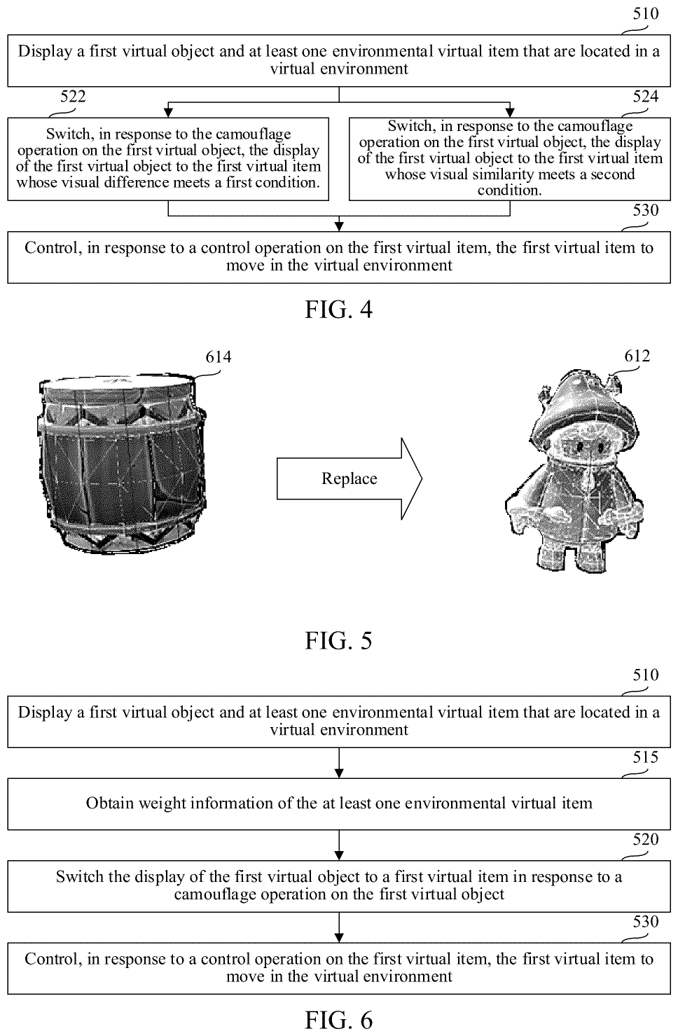

FIG. 4 is a flowchart of a virtual object transformation method according to an aspect of this disclosure. An example in which the method is applied to a terminal is used for description. In other words, in the aspect shown in FIG. 3, operation 520 may be implemented as operation 522 or operation 524.

Operation 522: Switch, in response to the camouflage operation on the first virtual object, the display of the first virtual object to the first virtual item whose visual difference meets a first condition. For example, the first virtual object is output for display based on a visual difference between at least one display attribute of the first virtual object and at least one display attribute of the first virtual item.

For example, in this operation, the environmental virtual item includes the first virtual object. As described above, the type range of the first virtual item is a subset of the type range of the at least one environmental virtual item. Specifically, the first virtual item is determined from the at least one environmental virtual item. A type of the first virtual item is the same as a type of an environmental virtual item in the virtual environment.

For example, when the environmental virtual item includes the first virtual object, the first virtual object and the environmental virtual item in the virtual environment have the same appearance. The camouflage operation on the first virtual object indicates that even if the first virtual object is the same as the environmental virtual item in the virtual environment, it is not beneficial to hiding in the virtual environment. By determining the first virtual item from a candidate object pool, an appearance difference between the first virtual item and the first virtual object is increased, thereby avoiding that the changed first virtual item remains similar to the first virtual object.

For example, even if the first virtual object is the same as the environmental virtual item in the virtual environment, it is not beneficial to hiding in the virtual environment due to reasons such as the first virtual object having a large virtual volume, or the environmental virtual items being densely positioned in the virtual environment and having a distance from the first virtual object exceeding a distance threshold, making it difficult for the first virtual object to move in time to the position of the environmental virtual item in the virtual environment. The foregoing reasons are not limited in the aspects of this disclosure.

For example, the visual difference indicates a difference in appearance attributes between the first virtual object and the first virtual item. In an example, the visual difference meeting the first condition indicates that the first virtual object and the first virtual item differ in at least two appearance attributes. Alternatively, the visual difference meeting the first condition indicates that the first virtual object and the first virtual item differ at least two appearance attributes of color, material, texture, three-dimensional structure, dimension, or fill pattern.

In an example, the appearance attributes include, but are not limited to, at least one of the following:

Color: it indicates a texture mapping color of a virtual object. The color may be a single color, or may be a combination of a plurality of colors.

Material: it indicates that a virtual object simulates a real object by using parameter information such as reflectivity and transparency, for example, a metal material, a glass material, or a rubber material.

Texture: it indicates that a virtual object simulates bumps and grooves of a real object in a manner such as texture mapping.

Three-dimensional structure: it indicates structural information of a virtual object in a three-dimensional space, for example: at least one of three-dimensional shapes such as a sphere, an ellipsoid, a cylinder, a cone, a prism, and a pyramid, or a three-dimensional structure formed by a combination thereof. For example, the three-dimensional structure may alternatively be a solid structure whose outer surface is obtained by splicing triangles.

Dimension: it indicates information that describes dimensions of a virtual object, such as a length, a width, and a height of the virtual object in a three-dimensional space.

Fill pattern: it indicates a pattern mapped onto an outer surface texture of a virtual object.

For example, the first virtual item and the first virtual object differ in at least two appearance attributes. The first virtual item is determined from the subset of the type range of the environmental virtual item. For example, environmental virtual items differing from the first virtual object in at least two different appearance attributes are filtered among the types of the environmental virtual items, to obtain at least one candidate type; and the first virtual item is determined from the at least one candidate type. Further, the first virtual item is determined from the filtered objects when there is more than one filtered object.

Operation 524: Switch, in response to the camouflage operation on the first virtual object, the display of the first virtual object to the first virtual item whose visual similarity meets a second condition. For example, the first virtual item is determined based on a visual similarity of the first virtual item with a surrounding area of the first virtual object in the virtual environment. The surrounding area is within a proximity distance threshold.

For example, the first virtual item is determined from the at least one environmental virtual item. Specifically, in this operation, an adjacent environmental item in the virtual environment and the first virtual item have at least two same appearance attributes.

For example, the adjacent environmental item is an environmental virtual item whose distance from the first virtual object is less than a preset proximity distance threshold. By switching the display of the first virtual object to the first virtual item, the first virtual item and the adjacent environmental item within the proximity distance threshold have similar appearance attributes (for example, have at least two same appearance attributes), which facilitates concealment of the first virtual item in the virtual environment by using the same or similar appearance of the first virtual item and the adjacent environmental item.

For example, the proximity distance threshold between the adjacent environmental item and the first virtual object may be preset, or may be determined based on the adjacent environmental item. For example, the proximity distance threshold decreases as a dimension of the adjacent environmental item increases. For example, as a volume in the virtual environment increases, visual significance increases. In other words, in the virtual environment, as a volume of the first virtual item increases, difficulty of hiding in the virtual environment increases. Further, the proximity distance threshold decreases as the dimension of the adjacent environmental item increases, and a distance between the transformed first virtual item and the adjacent environmental item is reduced, to facilitate controlling the first virtual item to approach the adjacent environmental item in time or to hide around the adjacent environmental item by using an appearance the same as or similar to that of the adjacent environmental item.

For example, the visual similarity indicates a similarity in appearance attributes between the adjacent environmental item and the first virtual item. In an example, the visual similarity meeting the second condition indicates that the first virtual object and the first virtual item have at least two same appearance attributes. Alternatively, the visual similarity meeting the second condition indicates that the first virtual object and the first virtual item have at least two same appearance attributes of color, material, texture, three-dimensional structure, dimension, or fill pattern. For descriptions about the foregoing appearance attributes, refer to operation 522 above, and details are not described herein again.

In some aspects, in an implementation, the environmental virtual item does not include the first virtual object, and when the environmental virtual item does not include the first virtual object, the first virtual object and the environmental virtual item in the virtual environment have different appearances. The camouflage operation on the first virtual object indicates that the first virtual object has a poor simulation effect on the environmental virtual item and has a large appearance difference; or the first virtual object does not simulate the environmental virtual item in the virtual environment, which is not beneficial to hiding in the virtual environment. By switching the display of the first virtual object to the first virtual item, targeted simulation of the adjacent environmental item in the virtual environment is achieved, which facilitates concealment of the first virtual item in the virtual environment by using the same or similar appearance of the first virtual item and the adjacent environmental item.

Operation 520 in FIG. 4 may be implemented as operation 522 or operation 524, to indicate that operation 522 in this aspect and operation 510 and operation 530 in FIG. 3 can be combined into a new aspect to be independently implemented. This is not limited in this disclosure. Similarly, operation 524 in this aspect can alternatively be combined with operation 510 and operation 530 in FIG. 3 into a new aspect to be independently implemented. This is not limited in this disclosure. In an example, the foregoing two implementations may also be combined, that is, the display of the first virtual object is switched to the first virtual item. The visual difference between the first virtual item and the first virtual object meets the first condition, and the similarity (visual similarity) in appearance attributes between the adjacent environmental item and the first virtual item meets the second condition.

In conclusion, according to the method provided in this aspect, by performing the camouflage operation to switch the display of the first virtual object, the display of the first virtual object is changed to the first virtual item based on the visual difference or the visual similarity, changing the appearance of the first virtual object. The changed first virtual item is of the same type as the at least one environmental virtual item, ensuring that an environmental virtual item having the same appearance as the first virtual item exists in the virtual environment. This facilitates hiding in the virtual environment by using the appearance of the first virtual item, thereby expanding manners of changing the appearance of the virtual object in the virtual environment.

Next, the first virtual item is further described.

In an implementation, the first virtual item in operation 520 can be implemented as any one of the following:
The type of the first virtual item is determined from the at least one environmental virtual item.

For example, environmental virtual items of different types may have different or the same weight information, and the weight information indicates a probability that the environmental virtual item is selected as the first virtual item in a determining process.
The type of the first virtual item is the same as a type of environmental virtual items having a largest quantity in the virtual environment.

For example, when a quantity of environmental virtual objects in the virtual environment increases, environmental virtual items are increasingly common in the environment. Determining the type of the first virtual item to be the same type of the environmental virtual items having the largest quantity in the virtual environment facilitates concealment in the virtual environment by using the appearance the same as or similar to that of the environmental virtual item, for example, by concealing the first virtual item near deployment positions of a plurality of environmental virtual items.
The first virtual item is an environmental virtual item in the virtual environment that is closest to the first virtual object.

For example, by determining the first virtual item as the environmental virtual item in the virtual environment that is closest to the first virtual object, it ensures that environmental virtual items having the same appearance attribute surround the first virtual item. This facilitates controlling the first virtual item to move in the virtual environment, and observing and referencing features of the environmental virtual item in the virtual environment to conceal the first virtual item. For example, the type of the first virtual item is the same as the type of the environmental virtual item in the virtual environment that is closest to the first virtual object; and the first virtual item is determined as an item of the same type as the environmental virtual item in the virtual environment that is closest to the first virtual object.
The first virtual item is an environmental virtual item in the virtual environment that is arranged according to a preset interval rule.

For example, the environmental virtual items arranged according to the preset interval rule in the virtual environment are arranged in the virtual environment in an array or annular manner. Determining the first virtual item as the environmental virtual item arranged according to the preset interval rule facilitates concealment by using the environmental virtual items arranged in the array or annular manner. Further, when the environmental virtual items arranged according to the preset interval rule are vacant, the first virtual item may be controlled to move to the vacant position, to complete the array or circular pattern of the environmental virtual items, and the first virtual item is concealed among a plurality of environmental virtual items having the same appearance. For example, the type of the first virtual item is the same as the type of the environmental virtual item in the virtual environment that is arranged according to the preset interval rule; and the first virtual item is determined as an item of the same type as the environmental virtual item arranged according to the preset interval rule.
The first virtual item is an environmental virtual item whose arrangement density in the virtual environment exceeds a first threshold.

For example, the environmental virtual item whose arrangement density exceeds the first threshold may be an object such as a virtual tree, a virtual box, or a virtual vehicle. Determining the first virtual item as the environmental virtual item facilitates hiding the first virtual item among the plurality of environmental virtual items to avoid being found. For example, a position in which arrangement density exceeds the first threshold is a position in which the plurality of environmental virtual items are densely placed or densely grown. For example, a position in which arrangement density of the virtual tree exceeds the first threshold is a virtual forest, and a position in which arrangement density of the virtual box exceeds the first threshold is a virtual cargo yard. Hiding the first virtual item at the foregoing position does not have visual significance. In addition, the difficulty of finding the first virtual item is increased due to the plurality of environmental virtual items having the same appearance. For example, the type of the first virtual item is the same as a type of the environmental virtual item whose arrangement density in the virtual environment exceeds the first threshold; and the first virtual item is determined as an item of the same type as the environmental virtual item whose arrangement density in the virtual environment exceeds the first threshold.
The first virtual item and an environmental virtual item that has been deployed in the virtual environment are the same virtual item.

For example, the display of the first virtual object is switched to the first virtual item, to indicate a virtual object controlled by a control account to be changed to the environmental virtual item that has been deployed in the virtual environment. For example, a virtual vase is deployed in the virtual environment, and the virtual vase is determined as the first virtual item in response to the camouflage operation. The first virtual item and the environmental virtual item that has been deployed in the virtual environment are the same virtual item.

For example, the environmental virtual item that has been deployed in the virtual environment is directly determined as the first virtual object, so that an environmental virtual item that already exists in the virtual environment is directly used for hiding. This avoids that comparison between initial observation information of the virtual environment when no player character exists and battle observation information in the virtual match negatively affects hiding of the first virtual item.
The first virtual item and an environmental virtual item that has been deployed in the virtual environment have a matching relationship.

For example, the matching relationship indicates that the first virtual item and the environmental virtual item are an item group matching for use; or the first virtual item and the environmental virtual item may form a group of items that can be positionally spliced together to form an appearance of another virtual item. For example, the item group formed by the first virtual item and the environmental virtual item includes a virtual teacup and a virtual teapot. In a real world, the teacup and the teapot are items matching for use. For example, the item group formed by the first virtual item and the environmental virtual item includes a virtual vehicle body and virtual tires. The virtual vehicle body is spliced above the virtual tires, to form the appearance of the virtual vehicle. For example, determining the first virtual item as an item having the matching relationship with the environmental virtual item that has been deployed in the virtual environment facilitates controlling the first virtual item to approach the environmental virtual item in the virtual environment, thereby increasing the plausibility in the virtual environment to achieve concealment in the virtual environment.

For example, in this disclosure, a transition animation may exist when the display of the first virtual object is switched to the first virtual item. This is not limited in this aspect. For example, by switching the display of the first virtual object to the first virtual item, an appearance of the virtual object controlled by the control account currently logged in on the terminal is changed, enabling the first virtual item to hide in the virtual environment for virtual matches Implementations of the first virtual item described in the aspects may be combined with at least one of operation 522 or operation 524 in FIG. 4 into an aspect that conforms to the constraint of at least one of operation 522 or operation 524 and conforms to the constraint of the implementations of the first virtual item. This is not limited in this disclosure.

In an implementation, switching the display of the first virtual object to the first virtual item can be implemented as: replacing a three-dimensional model of the first virtual object with a three-dimensional model of the first virtual item, and displaying the three-dimensional model of the first virtual item.

For example, the three-dimensional model is a model formed by splicing a plurality of triangular patches to form an outer surface, and is also referred to as a model mesh or a skeleton model. The three-dimensional model of the first virtual object is replaced with the three-dimensional model of the first virtual item, so that the display of the first virtual object is switched to the first virtual item.

For example, displaying a three-dimensional mesh model of the first virtual item includes, but is not limited to, filling a color or adding a map picture on a triangular patch on an outer surface of the three-dimensional model of the first virtual item, and performing rendering processing on the three-dimensional model, to display the first virtual item.

FIG. 5 is a schematic diagram of a three-dimensional model according to an aspect of this disclosure. For example, the first virtual object is a virtual puppet, and the first virtual item is a virtual wooden barrel. In response to the camouflage operation on the first virtual object, the display of a first three-dimensional model 612 of the virtual puppet is switched to a second three-dimensional model 614 of the virtual wooden barrel. An outer surface of the first three-dimensional model 612 of the virtual puppet and an outer surface of the second three-dimensional model 614 of the virtual wooden barrel are both formed by splicing triangles. Each triangle is filled with a color or a pattern to display the corresponding virtual puppet or virtual wooden barrel.

In conclusion, by performing the camouflage operation to switch the display of the first virtual object, the display of the first virtual object is changed to the first virtual item, changing the appearance of the first virtual object. The changed first virtual item is of the same type as the at least one environmental virtual item, ensuring that an environmental virtual item having the same appearance as the first virtual item exists in the virtual environment. This facilitates hiding in the virtual environment by using the appearance of the first virtual item, thereby expanding manners of changing the appearance of the virtual object in the virtual environment.

Next, weight information of an environmental virtual item is described.

FIG. 6 is a flowchart of a virtual object transformation method according to an aspect of this disclosure. An example in which the method is applied to a terminal is used for description. In other words, in the aspect shown in FIG. 3, operation 515 is further included.

Operation 515: Obtain weight information of the at least one environmental virtual item.

For example, the weight information is in a one-to-one correspondence with types of environmental virtual items, one type of environmental virtual item in the virtual environment corresponds to one piece of weight information, and the weight information indicates a probability that the environmental virtual item is selected as the first virtual item. For example, the weight information may be represented as a probability that the type of the first virtual item is the same as the type of the environmental virtual item. For example, the weight information corresponding to the type of the environmental virtual item in the virtual environment is obtained through a limited quantity of statistical analyses on the type of the first virtual item.

For example, the weight information may be information on which normalization processing is performed. For example, a sum of weight information of all types of environmental virtual items in the virtual environment is 1; or the weight information may be information on which normalization processing is not performed. For example, by comparing weight information of two types of environmental virtual items, a probability that the type of the first virtual item is the same as either of the two types of environmental virtual items is determined.

For example, the weight information may be preset, or may be determined based on the environmental virtual item included in the virtual environment, or may be determined based on historical match information. This is not limited in this aspect. A manner of determining the weight information has at least the following two implementations, and is described by using the following aspect.

Implementation 1: The weight information is determined based on deployment information of the environmental virtual item in the virtual environment.

Implementation 2: The weight information is determined based on historical matches.

In implementation 1, operation 515 above can be implemented as sub-operation 15a:

Sub-operation 15a: Determine weight information of the at least one type of environmental virtual item based on deployment information of the environmental virtual item in the virtual environment.

For example, the deployment information of the environmental virtual item indicates a deployment status of the environmental virtual item in the virtual environment, for example, at least one of information such as its position or quantity in the virtual environment. As described above, the weight information is in a one-to-one correspondence with types of environmental virtual items, and the deployment information of the environmental virtual items indicates a deployment status of environmental virtual items of the same type in the virtual environment.

In some aspects, in an implementation, the weight information corresponding to the environmental virtual items is determined based on quantity information of the environmental virtual item in the virtual environment; and the quantity information and the weight information may be in a direct proportional relationship, or may be in another preset function relationship. Based on the quantity information, the unique weight information can be determined as the weight information corresponding to the environmental virtual item.

In a specific example, the quantity information and the weight information are in a positive correlation. As the quantity of environmental virtual objects in the virtual environment increases, the environmental virtual items are increasingly common in the environment. Increasing the weight information of the environmental virtual object facilitates concealment in the virtual environment by using the appearance the same as or similar to that of the environmental virtual item.

In some aspects, in another implementation, the weight information corresponding to the environmental virtual item is determined based on distance information between the environmental virtual item and the first virtual object. Similar to the quantity information above, the distance information and the weight information may be in a direct proportional relationship, or may be in another preset function relationship.

In a specific example, the distance information and the weight information are in an inverse correlation. As the distance between the first virtual object and the environmental virtual item increases, time consumed for the transformed first virtual object to approach the environmental virtual item increases. Reducing the weight information of the environmental virtual object facilitates the transformed first virtual object to approach the environmental virtual item in time, enabling concealment in the virtual environment.

In implementation 2, operation 515 above can be implemented as sub-operation 15b:

Sub-operation 15b: Determine the weight information corresponding to the environmental virtual item based on a quantity of times that the environmental virtual item is found or time consumed to be found in historical matches.

For example, the historical matches are usually past matches participated in by a control account that is currently logged in on a terminal, to achieve targeted determining of the weight information corresponding to the environmental virtual item in a current match of the control account based on the past matches of the control account. However, it does not exclude that the historical matches are past matches of any participant account in the current match, or the virtual environment is any historical match provided with an environment in which the second virtual object searches for the transformed first virtual object.

For example, descriptions are provided by using an example in which the historical matches are past matches in which the control account currently logged in on the terminal participates. In the historical matches, the control account may be the first virtual object hidden in the virtual environment, or may be the second virtual object that searches for the transformed first virtual object in the virtual environment. In an example, the quantity of times of being found and the weight information are in an inverse correlation, and the time consumed to be found and the weight information are in a positive correlation.

In conclusion, by performing the camouflage operation to switch the display of the first virtual object, the display of the first virtual object is changed to the first virtual item, changing the appearance of the first virtual object. By obtaining the weight information of the environmental virtual item, a probability of being selected as the first virtual item is set for different types of environmental virtual items. The changed first virtual item is of the same type as the at least one environmental virtual item, ensuring that an environmental virtual item having the same appearance as the first virtual item exists in the virtual environment. This facilitates hiding in the virtual environment by using the appearance of the first virtual item, thereby expanding manners of changing the appearance of the virtual object in the virtual environment.

Next, a type range of the first virtual item and a type range of the at least one environmental virtual item are described.

Referring to the description in operation 520, the type range of the first virtual item is a subset of the type range of the at least one environmental virtual item. It may be determined, through a limited quantity of statistical analyses, that the type range of the first virtual item is the subset of the type range of the at least one environmental virtual item. For example, after operation 520 is repeatedly performed for n times, a statistical analysis is performed on the first virtual item after first switching for display, and if the first virtual item obtained after operation 520 is repeatedly performed for n times and the environmental virtual item in the virtual environment both have the same type, the type range of the first virtual item is the subset of the type range of the at least one environmental virtual item. For example, n is an empirical value greater than 1, for example, 100 or 500. In an example, n is an integer multiple, for example, 5 times, of a quantity of types of environmental virtual items. When there are 20 types of environmental virtual items in the virtual environment, a statistical analysis is performed on the first virtual item obtained by repeatedly executing operation 520 for 20*5=100 times. If the first virtual item and the environmental virtual item in the virtual environment both have the same type, it is determined that manners of switching the display of the first virtual object has been exhausted, and a type range of the first virtual item after being switched for display is a subset of the type range of the at least one environmental virtual item.

Further, the following three aspects are used for description.

In an example, the type range of the first virtual item is a first subset of the type range of the at least one environmental virtual item.

For example, the virtual environment includes at least two virtual scenes connected by a teleportation point. For example, the first subset includes one or more item types, and the item types included in the first subset are types of some or all environmental virtual items in the virtual environment. Further, the at least two virtual scenes in the virtual environment are virtual environments independent of each other, for example, corresponding to different virtual maps. For example, the environmental virtual item in the first subset and the first virtual object are located in the same virtual scene. For example, the first virtual item transformed from the first virtual object is of the same type as the at least one environmental virtual item in a virtual scene in which the first virtual object is located. For example, the first virtual item is determined within a range of the first subset, and the first subset is a set of types of environmental virtual items in the virtual scene in which the first virtual object is located.

For example, the teleportation point is a connection point between at least two virtual scenes. For example, the two virtual scenes include a first room and a second room, and the teleportation point corresponds to doors of the first room and the second room. If the teleportation point is triggered in the first room, a transfer to the second room is performed. Further, the first room and the second room are virtual environments independent of each other. For example, in a process of transferring from the first room to the second room, scene loading is required, and a transfer to the second room is performed by switching the display. and/or, when the viewpoint in the second room, the first room cannot be observed by using a virtual camera.

In some aspects, a control account that controls the first virtual object carries an environment identifier of a virtual environment in which the control account is located, and the environment identifier is added to the control account when the first virtual object enters the virtual environment. For example, the position of the first virtual object is determined by reading the environment identifier carried in the control account. Further, the environment identifier includes a scene identifier, and the scene identifier is added when the first virtual object enters a virtual scene in the virtual environment, and indicates a virtual scene to which a current position of the first virtual object belongs. In different implementations, the environment identifier includes a region identifier, and the region identifier corresponds to a virtual region in the virtual environment. For descriptions about the virtual region, calculation is further described in the following aspects.

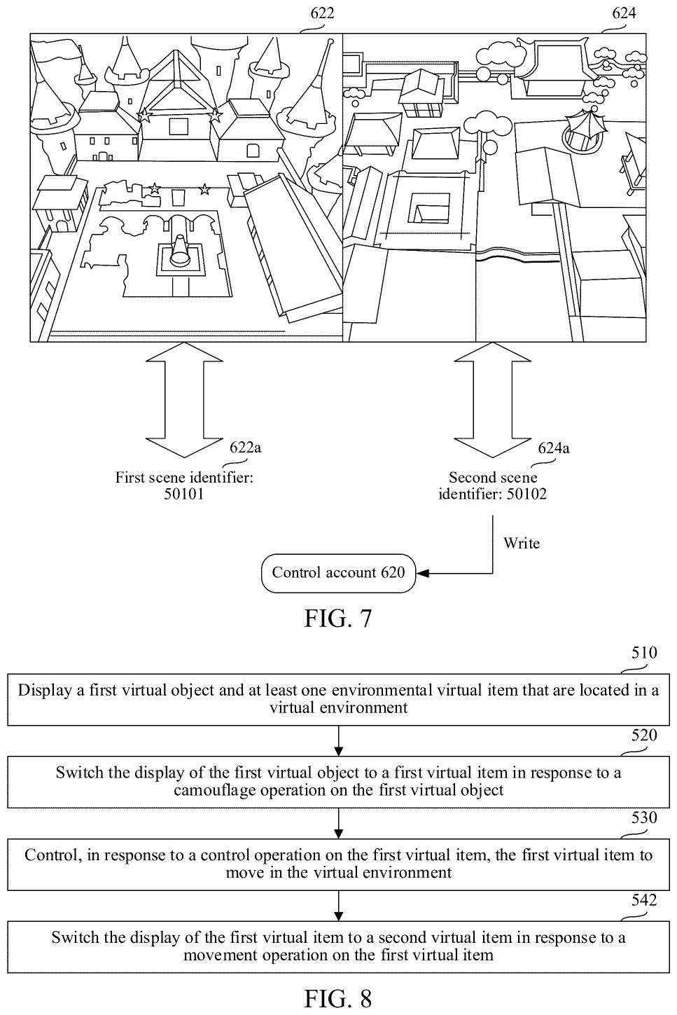

FIG. 7 is a schematic diagram of a virtual environment identifier according to an aspect of this disclosure. A castle virtual scene 622 corresponds to a first environment identifier 622a, and a garden virtual scene 624 corresponds to a second environment identifier 624a. When the first virtual object enters the garden virtual scene 624, the corresponding second environment identifier 624a is written into a control account 620 of the first virtual object. When a position corresponding to the first virtual object needs to be determined, the second environment identifier 624a is read from the control account 620.

In conclusion, by performing the camouflage operation to switch the display of the first virtual object, the display of the first virtual object is changed to the first virtual item, changing the appearance of the first virtual object. The changed first virtual item is of the same type as the environmental virtual item in the virtual scene, ensuring that an environmental virtual item having the same appearance as the first virtual item exists in the virtual environment. This facilitates hiding in the virtual environment by using the appearance of the first virtual item, thereby expanding manners of changing the appearance of the virtual object in the virtual environment.

In another example, the type range of the first virtual item is a second subset of the type range of the at least one environmental virtual item.

For example, the virtual environment includes at least two virtual regions having different environment types. For example, the second subset includes one or more item types, and the item types included in the second subset are types of some or all environmental virtual items in the virtual environment. Further, the environment type of the virtual region indicates an environment type constructed by virtual items in the virtual region. Specifically, division manners of environment types include, but are not limited to, at least one of the following.

Based on whether a virtual building exists inside the virtual region, the environment type includes at least one of an indoor region or an outdoor region. In an example, if the position of the first virtual object belongs to the indoor region, the second subset is a type set of environmental virtual items appearing in at least one indoor region in the virtual environment.

Based on height information of a virtual altitude of a virtual region, the environment type includes at least one of a valley region, a plain region, or a mountainous region. In an example, if the position of the first virtual object belongs to the plain region, the second subset is a type set of environmental virtual items appearing in at least one plain region in the virtual environment.

Based on types of virtual plants in the virtual region, the environment type includes at least one of a wasteland region, a shrubland region, a forest region, or a grassland region. In an example, if the position of the first virtual object belongs to the forest region, the second subset is a type set of environmental virtual items appearing in at least one forest region in the virtual environment.

Based on building types of the virtual region, the environment type includes at least one of a rural region or an urban region. In an example, if the position of the first virtual object belongs to the urban region, the second subset is a type set of environmental virtual items appearing in at least one urban region in the virtual environment.

For example, the environmental virtual item in the second subset and the first virtual object are located in virtual regions of the same environment type. For example, the first virtual item transformed from the first virtual object is of the same type as at least one environmental virtual item in a virtual region to which the first virtual object belongs. For example, the first virtual item is determined within a range of the second subset, and the second subset is a set of types of environmental virtual items in the virtual region in which the first virtual object is located.

The division manners of the environment types described above may be combined with each other. For example, the environment types are divided from two dimensions, namely, the type of the virtual plant in the virtual region and the height information of the virtual altitude of the virtual region. The position of the first virtual object belongs to the plain region in a dimension of the height information of the virtual altitude, and belongs to the forest region in a dimension of the type of the virtual plant. Then, the second subset is a type set of environmental virtual items appearing in at least one region that belongs to both the plain region and the forest region in the virtual environment.

For example, region shapes of the at least two virtual regions having different environment types in the virtual environment may be regular shapes such as rectangle, circle, and ellipse, or may be irregular shapes formed by line segments or curves. One or more virtual regions belonging to the same environment type may exist in the virtual environment.

For example, when the first virtual object is located in the indoor region, types of the virtual items included in the second subset include, but are not limited to: at least one of a book stack, a floor lamp, a wooden barrel, a decorative armor, an iron box, a wooden box, a coat rack, a glass cup, a vase, a floor mirror, a candlestick, a telescope, a flag, an item shelf, a floor clock, or the like. Further, the indoor region in which the first virtual object is located is a region in a castle building.

For example, when the first virtual object is located in the outdoor region, types of the virtual items included in the second subset include, but are not limited to: at least one of a grass cluster, a rock, a wooden box, a wooden stake, a stone sculpture, a tree, a shrub, a meaty plant, a trophy, an orange, a tomato, a plastic ball, a stone jar, an iron box, leaves, a fire pit, a humanoid sculpture, or the like. Further, the indoor region in which the first virtual object is located is a region in the virtual forest.

In conclusion, by performing the camouflage operation to switch the display of the first virtual object, the display of the first virtual object is changed to the first virtual item, changing the appearance of the first virtual object. The changed first virtual item is of the same type as the environmental virtual item in the virtual region, ensuring that an environmental virtual item having the same appearance as the first virtual item exists in the virtual environment. This facilitates hiding in the virtual environment by using the appearance of the first virtual item, thereby expanding manners of changing the appearance of the virtual object in the virtual environment.

In still another example, the type range of the first virtual item is a third subset of the type range of the at least one environmental virtual item.

For example, a distance between the environmental virtual item in the third subset and the first virtual object is less than a region distance threshold. For example, the third subset includes one or more item types, and the item types included in the third subset are types of some or all environmental virtual items in the virtual environment.

For example, the region distance threshold may be preset, or may be determined based on the first virtual object. For example, the region distance threshold increases as a maximum movement speed of the first virtual object increases. For example, the region distance threshold indicates an upper limit of a safety distance by which the first virtual object can move to a position of the environmental virtual object in the virtual environment in time after being transformed. In an implementation, the region distance threshold is a product of a movement speed of the first virtual object and a preset duration. For example, the preset duration is 5 seconds.

For example, the first virtual item transformed from the first virtual object is of the same type as at least one environmental virtual item within the region distance threshold. For example, the first virtual item is determined within a range of the third subset, and the third subset is a set of types of environmental virtual items whose distances to the first virtual object are less than the region distance threshold.

In conclusion, by performing the camouflage operation to switch the display of the first virtual object, the display of the first virtual object is changed to the first virtual item, changing the appearance of the first virtual object. The changed first virtual item is of the same type as the environmental virtual item located in an adjacent region, ensuring that an environmental virtual item having the same appearance as the first virtual item exists in the virtual environment. This facilitates hiding in the virtual environment by using the appearance of the first virtual item, thereby expanding manners of changing the appearance of the virtual object in the virtual environment.

FIG. 8 is a flowchart of a virtual object transformation method according to an aspect of this disclosure. An example in which the method is applied to a terminal is used for description. In other words, in the aspect shown in FIG. 3, operation 542 is further included.

Operation 542: Switch the display of the first virtual item to a second virtual item in response to a movement operation on the first virtual item. For example, the output for display of the first virtual item is switched to a second virtual item based on a movement operation performed on the first virtual item.

For example, a distance between the first virtual item and a first environmental item is greater than a first distance threshold, a distance between the second virtual item and a second environmental item is less than a second distance threshold, the first environmental item and the first virtual item are of the same type, and the second environmental item and the second virtual item are of the same type.

For example, during the movement of the first virtual item, adaptively changing the virtual item based on the movement operation can ensure an appearance similarity between the virtual item and surrounding environmental virtual items. This facilitates controlling the second virtual item to quickly approach the second environmental item in the virtual environment, thereby enabling concealment by using an appearance the same as that of the second environmental item.

For example, the first distance threshold and the second distance threshold may be the same or may be different. Similar to the foregoing proximity distance threshold and/or region distance threshold, the first distance threshold may be determined based on a dimension of the first virtual item. For example, the first distance threshold decreases as the dimension of the first virtual item increases. Alternatively, the first distance threshold may be determined based on a movement speed of the first virtual item. For example, the first distance threshold increases as a maximum movement speed of the first virtual item increases.

In some aspects, in an implementation, the movement of the first virtual item in operation 542 causes the first virtual item to cross from one virtual region to another virtual region. For related descriptions of virtual regions, refer to the related descriptions of environment types and virtual regions above. Environment types of the two virtual regions in which the first virtual item is located before and after the movement operation are different. When the first virtual item crosses the virtual regions, there is a risk that the first virtual item and the environmental virtual items in the moved virtual region are of different types and have a large appearance difference. As described above, the distance between the first virtual item and the first environmental item is greater than the first distance threshold, and the distance between the second virtual item and the second environmental item is less than the second distance threshold. The first virtual item cannot quickly approach the first environmental item in the virtual environment. Adaptively changing the style of the virtual item facilitates the first virtual item to hide in the virtual environment by using the appearance of the second virtual item, thereby expanding manners of changing the appearance of the virtual object in the virtual environment.

In conclusion, by performing the camouflage operation to switch the display of the first virtual object, the display of the first virtual object is changed to the first virtual item, changing the appearance of the first virtual object. Through the movement operation, the display of the first virtual item is adaptively switched to the second virtual item. Both the changed first virtual item and second virtual item are of the same type as the at least one environmental virtual item, ensuring that an environmental virtual item having the same appearance as the first virtual item exists in the virtual environment. This facilitates hiding in the virtual environment by using the appearance of the second virtual item, thereby expanding manners of changing the appearance of the virtual object in the virtual environment.

In an application scenario, an application providing a virtual environment is a game application, and the game application provides at least an evasion arena mode. In the evasion arena mode, a virtual camp in which the first virtual object is located may be referred to as a stealth side or an evading side, and a virtual camp in which the second virtual object is located may be referred to as a guarding side or a searching side. A virtual arena objective of the virtual camp of the stealth side is to remain concealed in the virtual environment, to avoid a virtual attack from the virtual camp of the guarding side. A virtual arena objective of the virtual camp of the guarding side is to search for a virtual character of the virtual camp of the stealth side, and initiate a virtual attack to the virtual character.

For example: After a virtual battle match starts, the first virtual object blends into environmental virtual items arranged in a virtual environment by changing its appearance to avoid being found by the second virtual object. The second virtual object needs to find, from a plurality of environmental virtual items in the virtual environment, a first virtual item transformed from the first virtual object, and perform a virtual attack.

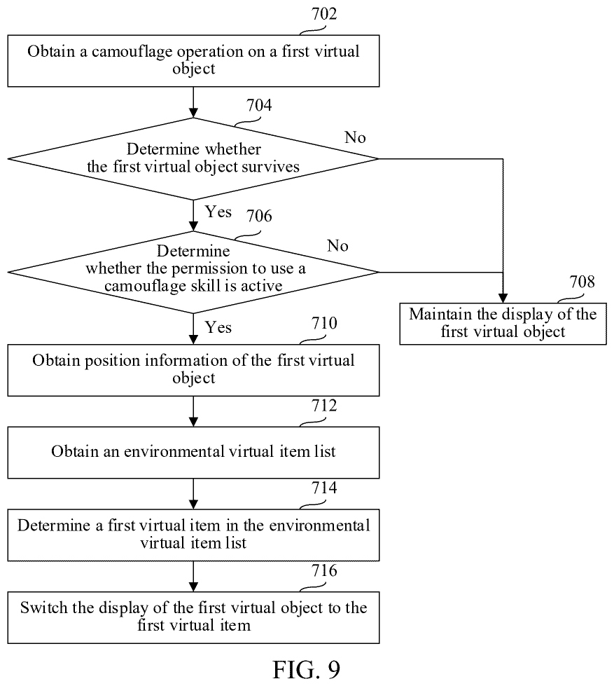

FIG. 9 is a flowchart of a virtual object transformation method according to an aspect of this disclosure. An example in which the method is applied to the terminal is used for description. The method includes the following operations:

Operation 702: Obtain a camouflage operation on a first virtual object.

For example, the camouflage operation is configured for switching the display of an appearance of the first virtual object, and the camouflage operation is an operation on the first virtual object. Implementations of the camouflage operation on the first virtual object include, but are not limited to, at least one of the following: tapping, sliding, or rotating. For example: tapping on a touchscreen or a key, sliding on a touchscreen or a game controller, and rotating a terminal or a game controller.

Operation 704: Determine whether the first virtual object survives.

For example, when the first virtual object survives, operation 706 is performed; and when the first virtual object does not survive, operation 708 is performed.

For example, whether the first virtual object survives is determined by querying virtual health points of the first virtual object. For example, when the virtual health points of the first virtual object are greater than 0, the first virtual object survives; otherwise, the first virtual object does not survive.

For example, the first virtual object is a virtual object controlled by a control account currently logged in on a terminal. In the aspects of this disclosure, the appearance of the first virtual object is not limited. The first virtual object may be an image of at least one virtual character of a virtual character, a virtual animal, or an animated character, or may be an image of at least one virtual item that has an appearance the same as that of an environmental virtual item, such as a virtual box, a virtual flower pot, and virtual stairs.

Operation 706: Determine whether the permission to use a camouflage skill is active.

For example, when the permission to use a camouflage skill is active, operation 710 is performed; and when the permission to use a camouflage skill is inactive, operation 708 is performed.

For example, whether the permission to use a camouflage skill is active is determined by querying whether the first virtual object is equipped with a camouflage skill, or whether the first virtual object carries a virtual item that releases a camouflage skill. Further, when the first virtual object is equipped with the camouflage skill, whether the permission to use a camouflage skill is inactive is determined by checking whether the camouflage skill is in a cooldown state.

Operation 708: Maintain the display of the first virtual object.

For example, when the first virtual object does not survive, or when the permission to use the camouflage skill is inactive, the display of the first virtual object is maintained, and switching the display of the first virtual object to the first virtual item is no longer performed.

Operation 710: Obtain position information of the first virtual object.

For example, the position information of the first virtual object in the virtual environment may be indicated by using an environment identifier. For descriptions about the environment identifier, refer to FIG. 7 above, and details are not described herein again. In a match, a virtual environment providing an evasion arena mode for the first virtual object is an island map. In another match, a virtual environment providing an evasion arena mode for the first virtual object is a city map. Environment identifiers of the island map and the city map are different. The environment identifier is attribute information of the first virtual object added when the first virtual object enters the virtual environment and participates in the evasion arena mode.

Operation 712: Obtain an environmental virtual item list.

For example, the environmental virtual item list includes virtual items that have been deployed in a virtual environment to which the first virtual object belongs. For example, the virtual items include, but are not limited to, at least one of objects such as a virtual tree, a virtual animal, a virtual box, a virtual flower pot, virtual staircases, or a virtual curtain.

Operation 714: Determine a first virtual item in the environmental virtual item list.

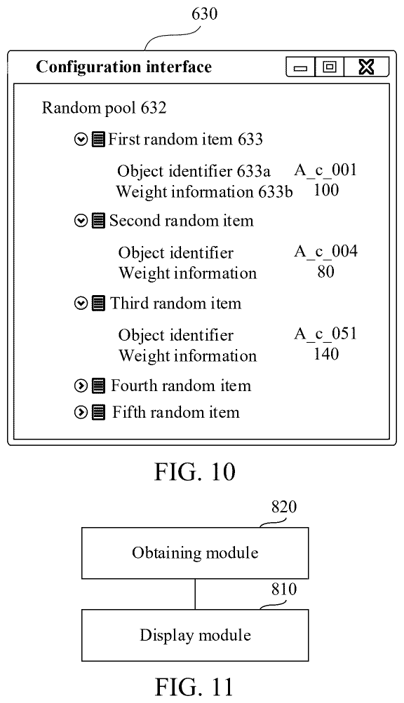

For example, the first virtual item may be determined from the environmental virtual item list by using a pool. The pool may be a random pool in some aspects. FIG. 10 is a schematic diagram of a random pool according to an aspect of this disclosure. A configuration interface 630 is a setting interface for the random pool 632. There are a plurality of environmental virtual items in the random pool 632, and the environmental virtual items correspond to random items in the random pool. In this aspect, the random pool includes a total of five random items: a first random item to a fifth random item. For example, the first random item 633 includes an object identifier 633a and weight information 633b. The object identifier 633a indicates an object identifier of an environmental virtual object corresponding to the first random item 633, and the weight information 633b indicates a probability that an environmental virtual item is selected as a first virtual item.

Operation 716: Switch the display of the first virtual object to the first virtual item.

For example, a three-dimensional model of the first virtual object is replaced with a three-dimensional model of the first virtual item, and the three-dimensional model of the first virtual item is displayed.

In some aspects, in an implementation, the method further includes:
obtaining an appearance hiding operation on the first virtual item; and hiding the display of the first virtual item in the virtual environment in response to the appearance hiding operation, the hidden display having a first effective period.

For example, after the hiding operation is used, the display of the first virtual item is hidden, to avoid being found by the second virtual object. In an example, a use interval of the hiding operation is 40 seconds. An effective period of each hidden display is 6 seconds.

In some aspects, in an implementation, the method further includes:
marking the display of a position of the first virtual item in the virtual environment when the first virtual item is selected by a detection operation, the marked display having a second effective period.

For example, when the first virtual item is selected by the detection operation, the position of the first virtual item is displayed in a virtual map, or the position of the first virtual item is indicated by using a directional arrow in the virtual environment. A manner of marking and displaying the first virtual item is not limited in this aspect. The marking and displaying the first virtual item indicates that the first virtual item has a prominent identifier of visual significance in the virtual environment. In an example, an effective period of each marked display is 15 seconds.

In conclusion, by performing the camouflage operation to switch the display of the first virtual object, the display of the first virtual object is changed to the first virtual item, changing the appearance of the first virtual object. The changed first virtual item is of the same type as the at least one environmental virtual item, ensuring that an environmental virtual item having the same appearance as the first virtual item exists in the virtual environment. This facilitates hiding in the virtual environment by using the appearance of the first virtual item, thereby expanding manners of changing the appearance of the virtual object in the virtual environment.

A person of ordinary skill in the art can understand that the foregoing aspects may be independently implemented, or the foregoing aspects can be freely combined into new aspects, to implement the virtual object transformation method of this disclosure.

FIG. 11 is a structural block diagram of a virtual object transformation apparatus according to an aspect of this disclosure. The apparatus includes:
a display module 810, configured to execute operation 510 in the aspect of FIG. 3, the virtual environment being an environment for a second virtual object to search for a deformed first virtual object; and the first virtual object and the second virtual object having opposite identities;
the display module 810 is further configured to perform operation 520 in the aspect of FIG. 3, a type range of the first virtual item is a subset of a type range of the at least one environmental virtual item; and
the display module 810 is further configured to perform operation 530 in the aspect of FIG. 3.

In an aspect of this disclosure, the display module 810 is further configured to perform operation 522 in the aspect of FIG. 4.

The visual difference indicates a difference in appearance attributes between the first virtual object and the first virtual item, and the environmental virtual item includes the first virtual object.

In an aspect of this disclosure, the display module 810 is further configured to perform operation 524 in the aspect of FIG. 4.

The visual similarity indicates a similarity in appearance attributes between an adjacent environmental item and the first virtual item, and a distance between the adjacent environmental item and the first virtual object is less than a proximity distance threshold.

In an aspect of this disclosure, a type of the first virtual item is determined from the at least one environmental virtual item; or
a type of the first virtual item is the same as a type of environmental virtual items having a largest quantity in the virtual environment; or
the first virtual item is an environmental virtual item in the virtual environment that is closest to the first virtual object; or
the first virtual item is an environmental virtual item in the virtual environment that is arranged according to a preset interval rule; or
the first virtual item is an environmental virtual item whose arrangement density in the virtual environment exceeds a first threshold; or
the first virtual item and an environmental virtual item that has been deployed in the virtual environment are the same virtual item; or
the first virtual item and an environmental virtual item that has been deployed in the virtual environment have a matching relationship.

In an aspect of this disclosure, the apparatus further includes:
an obtaining module 820, configured to perform operation 515 in the aspect of FIG. 6.

The weight information and types of the environmental virtual items are in a one-to-one correspondence, and the weight information indicates a probability that the environmental virtual item is selected as the first virtual item.

In an aspect of this disclosure, the obtaining module 820 is further configured to:
determine the weight information of the at least one environmental virtual item based on deployment information of the environmental virtual item in the virtual environment.

In an aspect of this disclosure, the obtaining module 820 is further configured for at least one of the following:
determine the weight information corresponding to the environmental virtual item based on quantity information of the environmental virtual item in the virtual environment; or
determine the weight information corresponding to the environmental virtual item based on distance information between the environmental virtual item and the first virtual object.

In an aspect of this disclosure, the obtaining module 820 is further configured to:
determine the weight information corresponding to the environmental virtual item based on a quantity of times that the environmental virtual item is found or time consumed to be found in historical matches.

In an aspect of this disclosure, the type range of the first virtual item is a first subset of the type range of the at least one environmental virtual item; and
an environmental virtual item in the first subset and the first virtual object are located in the same virtual scene, and the virtual environment includes at least two virtual scenes connected by a teleportation point.

In an aspect of this disclosure, the type range of the first virtual item is a second subset of the type range of the at least one environmental virtual item; and
an environmental virtual item in the second subset and the first virtual object are located in the same virtual region, and the virtual environment includes at least two virtual regions having different environment types.

In an aspect of this disclosure, the type range of the first virtual item is a third subset of the type range of the at least one environmental virtual item; and
a distance between an environmental virtual item in the third subset and the first virtual object is less than a region distance threshold.

In an aspect of this disclosure, the display module 810 is further configured to perform operation 542 in the aspect of FIG. 8.

A distance between the first virtual item and a first environmental item is greater than a first distance threshold, a distance between the second virtual item and a second environmental item is less than a second distance threshold, the first environmental item and the first virtual item are of the same type, and the second environmental item and the second virtual item of the same type.

When the apparatus provided in the foregoing aspects implements functions of the apparatus, only division of the foregoing functional modules is used an example for description. In actual application, the foregoing functions may be allocated and completed by different functional modules according to actual requirements, that is, the internal structure of the device is divided into different functional modules, to implement all or some of the functions described above.

Specific manners of executing operations by modules of the apparatus in the foregoing aspect are already described in detail in the aspects related to the method. Technical effects obtained by performing operations by the modules are the same as the technical effects in the aspects related to the method, and are not described in detail herein.

An aspect of this disclosure further provides a computer device. The computer device includes: a processor and a memory, the memory having a computer program stored therein; and the processor being configured to execute the computer program in the memory to implement the virtual object transformation method provided in the foregoing method aspects.

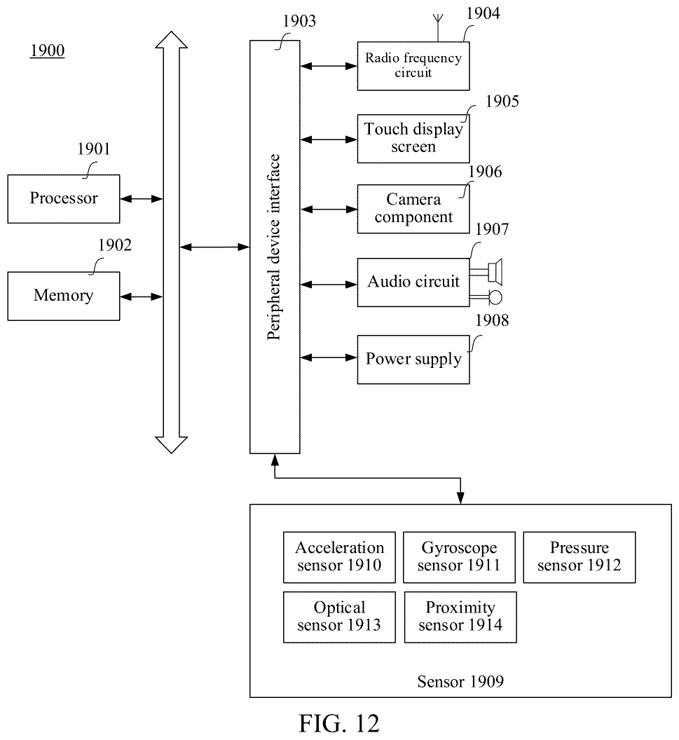

FIG. 12 is a structural block diagram of a terminal according to an aspect of this disclosure. The terminal 1900 may be: a smartphone, a tablet computer, a Moving Picture Experts Group Audio Layer III (MP3) player, a Moving Picture Experts Group Audio Layer IV (MP4) player, a notebook computer, or a desktop computer. The terminal 1900 may also be referred to by other names as user equipment, a portable terminal, a laptop terminal, a desktop terminal, or the like.

The terminal 1900 includes: a processor 1901 (for example, processing circuitry) and a memory 1902 (for example, a non-transitory computer-readable storage medium). The processor 1901 may include one or more processing cores, such as a 4-core processor or an 8-core processor. The processor 1901 may be implemented by using at least one hardware form of a digital signal processing (DSP), a field-programmable gate array (FPGA), and a programmable logic array (PLA). The processor 1901 may also include a main processor and a coprocessor. The main processor is a processor configured to process data in an active state, also referred to as a central processing unit (CPU). The coprocessor is a low-power consumption processor configured to process data in a standby state. In some aspects, the processor 1901 may be integrated with a graphics processing unit (GPU). The GPU is configured to be responsible for rendering and drawing content that needs to be displayed on a display screen. In some aspects, the processor 1901 may also include an artificial intelligence (AI) processor. The AI processor is configured to process a computing operation related to machine learning.

The memory 1902 may include one or more computer-readable storage media such as a non-transitory computer-readable storage medium. The computer-readable storage media may be non-transitory. The memory 1902 may also include a high-speed random access memory and a non-volatile memory, for example, one or more disk storage devices and flash storage devices. In some aspects, the non-transitory computer-readable storage medium in the memory 1902 is configured to store at least one instruction. The at least one instruction is executed by the processor 1901 to implement the virtual object transformation method provided in the method aspects in this disclosure.

In some aspects, the terminal 1900 may further include: a peripheral device interface 1903 and at least one peripheral device. The processor 1901, the memory 1902, and the peripheral device interface 1903 may be connected through a bus or a signal cable. Each peripheral device may be connected to the peripheral device interface 1903 through a bus, a signal cable, or a circuit board. Specifically, the peripheral device includes: at least one of a radio frequency circuit 1904, a touch display screen 1905, a camera component 1906, an audio circuit 1907, or a power supply 1908. The peripheral device interface 1903 may be configured to connect, to the processor 1901 and the memory 1902, at least one peripheral device related to an input/output (I/O). In some aspects, the processor 1901, the memory 1902, and the peripheral device interface 1903 are integrated on the same chip or the same circuit board. In some other aspects, any one or two of the processor 1901, the memory 1902, and the peripheral device interface 1903 may be implemented on a separate chip or circuit board. This is not limited in this aspect. The radio frequency circuit 1904 is configured to receive and transmit a radio frequency (RF) signal that is also referred to as an electromagnetic signal. The radio frequency circuit 1904 communicates with a communication network and another communication device through the electromagnetic signal. The radio frequency circuit 1904 may further include a circuit related to near field communication (NFC). The touch display screen 1905 is configured to display a user interface (UI). The UI may include a graph, a text, an icon, a video, and any combination thereof. The camera component 1906 is configured to collect an image or a video. In some aspects, the camera component 1906 includes a front-facing camera and a rear-facing camera. The audio circuit 1907 may include a microphone and a speaker. The microphone is configured to collect sound waves from a user and an environment and convert the sound waves into electrical signals that are inputted to the processor 1901 for processing or inputted to the radio frequency circuit 1904 for voice communication. The power supply 1908 is configured to supply power to components in the terminal 1900. The power supply 1908 may be an alternating current, a direct current, a disposable battery, or a rechargeable battery.

In some aspects, the terminal 1900 further includes one or more sensors 1909. The one or more sensors 1909 include, but are not limited to, an acceleration sensor 1910, a gyroscope sensor 1911, a pressure sensor 1912, an optical sensor 1913, and a proximity sensor 1914. The acceleration sensor 1910 may detect accelerations on three coordinate axes of a coordinate system established by the terminal 1900. The pressure sensor 1912 may be arranged on a side frame of the terminal 1900 and/or a lower layer of the touch display screen 1905. A holding signal of the user to the terminal 1900 is detected, and/or an operable control on the UI interface is controlled based on a pressure operation of the user on the touch display screen 1905. The optical sensor 1913 is configured to collect ambient light intensity. The proximity sensor 1914, also referred to as a distance sensor, is arranged on a front panel of the terminal 1900. The proximity sensor 1914 is configured to collect a distance between the user and a front surface of the terminal 1900.

It is noted that the foregoing structure does not constitute a limitation to the terminal 1900, and the terminal 1900 may include more or fewer components than those shown in the figure, or some components may be combined, or a different component arrangement may be used.

In an aspect, a chip is further provided. The chip includes a programmable logic circuit and/or program instructions, and when running on a computer device, the chip is configured to implement the virtual object transformation method in the foregoing aspect.

In an aspect, a computer program product is further provided. The computer program product includes computer instructions, and the computer instructions are stored in a computer-readable storage medium. A processor of a computer device reads the computer instructions from the computer-readable storage medium, and the processor reads and executes the computer instructions from the computer-readable storage medium to implement the virtual object transformation method provided in the foregoing method aspects.

In an aspect, a computer-readable storage medium, such as a non-transitory computer-readable medium, is further provided. The computer-readable storage medium has a computer program stored therein, and the computer program is loaded and executed by a processor to implement the virtual object transformation method provided in the foregoing method aspects.

It is noted that all or some of the operations of the foregoing aspects may be implemented by using hardware, or may be implemented by a program instructing relevant hardware. The program may be stored in a computer-readable storage medium. The storage medium may be a read-only memory, a magnetic disk, an optical disc, or the like.

It is noted that in the foregoing one or more examples, the functions described in the aspects of this disclosure may be implemented by using hardware, software, firmware, or any combination thereof. When implemented by using software, the functions can be stored in a computer-readable medium or can be used as one or more instructions or code in a computer-readable medium for transmission. The computer-readable medium includes a computer storage medium and a communication medium. The communication medium includes any medium that facilitates transmission of a computer program from one place to another. The storage medium may be any available medium accessible to a general-purpose or a special-purpose computer.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

What is claimed is:

1. A virtual object transformation method, comprising:
outputting for display a first virtual object in a virtual environment, the virtual environment including at least one virtual item and a second virtual object that searches for the first virtual object;
switching the output for display of the first virtual object to a first virtual item of the at least virtual item based on a camouflage operation being performed on the first virtual object, each of the at least one virtual item having an associated item type, and the first virtual item having an item type matching one of the associated item types; and
controlling the first virtual item to perform an action in the virtual environment based on a control operation performed on the first virtual item.

2. The method according to claim 1, wherein the switching the output for display of the first virtual object to the first virtual item comprises:
outputting for display the first virtual object based on a visual difference between at least one display attribute of the first virtual object and at least one display attribute of the first virtual item.

3. The method according to claim 1, wherein the switching the output for display of the first virtual object to the first virtual item comprises:
determining the first virtual item based on a visual similarity of the first virtual item with a surrounding area of the first virtual object in the virtual environment, the surrounding area being within a proximity distance threshold.

4. The method according to claim 1, further comprising:
selecting the first virtual item from the at least one virtual item based on at least one of:
which of the at least one virtual item has a largest quantity in the virtual environment;
which of the at least one virtual item in the virtual environment is closest to the first virtual object;
which of the at least one virtual item has an arrangement density that exceeds a first threshold;
which of the at least one virtual item has been deployed in the virtual environment; or
which of the at least one virtual item has a matching relationship with another one of the at least one virtual item deployed in the virtual environment.

5. The method according to claim 1, wherein each of the associated item types has corresponding weight information indicating a probability of a virtual item of the respective item type being selected as the first virtual item.

6. The method according to claim 5, wherein
the weight information is determined based on deployment information of the at least one virtual item in the virtual environment.

7. The method according to claim 6, wherein the weight information is determined based on one of (i) quantity information of the at least one virtual item in the virtual environment and (ii) distance information between the at least one virtual item and the first virtual object.

8. The method according to claim 5, further comprising:
determining the weight information for each of the associated item types based on at least one of:
a number of times virtual objects in previous game matches were discovered when the virtual objects are camouflaged as each of the virtual items; or
a time to discovery of the virtual objects in the previous game matches when the virtual objects are camouflaged as each of the virtual items.

9. The method according to claim 1, wherein the associated item types available for the camouflage operation are limited to item types present in a same virtual scene as the first virtual object.

10. The method according to claim 1, wherein the associated item types available for the camouflage operation are limited to item types present in a same virtual terrain as the first virtual object.

11. The method according to claim 1, wherein the associated item types available for the camouflage operation are limited to item types of environment virtual items located within a threshold distance of the first virtual object.

12. The method according claim 1, further comprising:
switching the output for display of the first virtual item to a second virtual item based on a movement operation performed on the first virtual item, wherein
a distance between the virtual object and a first one of the at least one virtual item associated with the first virtual item being greater than a first distance threshold,
a distance between the virtual object and a second one of the at least one virtual item associated with the second virtual item being less than a second distance threshold.

13. A virtual object transformation apparatus, comprising:
processing circuitry configured to:
output for display a first virtual object and at least one virtual item in a virtual environment, the virtual environment including a second virtual object that searches for the first virtual object;
switch the output for display of the first virtual object to a first virtual item of the at least one virtual item based on a camouflage operation being performed on the first virtual object, each of the at least one virtual item having an associated item type, and the first virtual item having an item type matching one of the associated item types; and
control the first virtual item to perform an action in the virtual environment based on a control operation performed on the first virtual item.

14. The apparatus according to claim 13, wherein the processing circuitry is configured to:
output for display the first virtual object based on a visual difference between at least one display attribute of the first virtual object and at least one display attribute of the first virtual item.

15. The apparatus according to claim 13, wherein the processing circuitry is configured to:
determine the first virtual item based on a visual similarity of the first virtual item with a surrounding area of the first virtual object in the virtual environment, the surrounding area being within a proximity distance threshold.

16. The apparatus according to claim 13, wherein the processing circuitry is configured to:
select the first virtual item from the at least one virtual item based on at least one of:
which of the at least one virtual item has a largest quantity in the virtual environment;
which of the at least one virtual item in the virtual environment is closest to the first virtual object; which of the at least one virtual item has an arrangement density that exceeds a first threshold;
which of the at least one virtual item has been deployed in the virtual environment; or
which of the at least one virtual item has a matching relationship with another one of the at least one virtual item deployed in the virtual environment.

17. The apparatus according to claim 13, wherein
each of the associated item types has corresponding weight information indicating a probability of a virtual item of the respective item type being selected as the first virtual item.

18. The apparatus according to claim 17, wherein
the weight information is determined based on deployment information of the at least one virtual item in the virtual environment.

19. The apparatus according to claim 18, wherein the weight information is determined based on one of (i) quantity information of the at least one virtual item in the virtual environment and (ii) distance information between the at least one virtual item and the first virtual object.

20. A non-transitory computer-readable storage medium storing instructions which, when executed by a processor, cause the processor to perform:
outputting for display a first virtual object and at least one virtual item in a virtual environment, the virtual environment including a second virtual object that searches for the first virtual object;
switching the output for display of the first virtual object to a first virtual item of the at least one virtual item based on a camouflage operation being performed on the first virtual object, each of the at least one virtual item having an associated item type, and the first virtual item having an item type matching one of the associated item types; and
controlling the first virtual item to perform an action in the virtual environment based on a control operation performed on the first virtual item.
